(19) United States
(12) Patent Application Publication
(10) Pub. No.: US 2009/0104109 A1
(43) Pub. Date: Apr. 23, 2009

(54) Method of reforming hydrocarbon by oxyhydrogen flame using three-tube burner

(75) Inventor: Tomoki YAMASAKI, (US)

Correspondence Address: BIRCH STEWART KOLASCH & BIRCH, PO BOX 747, FALLS CHURCH, VA, 22040-0747, US

(73) Assignee: Japan Hydrogen Co. Ltd.

(21) Appl. No.: 12/076,537

(22) Filed: Mar. 19, 2008

(30) Foreign Application Priority Data
Oct. 22, 2007 (JP) 2007-273891

(51) Int. Cl. C01B 3/24

(52) U.S. Cl. 423/650

(57) ABSTRACT

In order to produce hydrogen continuously without generating CO₂ from a hydrocarbon gas, continuous heating during operation has been necessary. The present invention is a method of reforming hydrocarbon with an oxyhydrogen flame using a three-tube burner wherein an operation of removing air from an entire apparatus, an operation of making crude hydrogen by heat-decomposing methane, and an operation of producing hydrogen with the crude hydrogen as a fuel are performed, which includes arranging a mesh metal catalyst tube at a tip of an inner tube of a blowpipe and an outer tube of the blowpipe of the burner; covering the metal catalyst tube with a ceramic insulating tube; heating the metal catalyst tube with an oxyhydrogen flame from between the inner tube of the blowpipe and the outer tube of the blowpipe of the burner; and decomposing hydrocarbon from the inner tube of the blowpipe into hydrogen and carbon.

### BACKGROUND OF THE INVENTION

1. Field of the Invention

The present invention relates to a method of reforming hydrocarbon with an oxyhydrogen flame using a three-tube burner by a method of producing hydrogen continuously without generating CO₂ using only a hydrocarbon gas and oxygen.

2. Description of the Related Art

The present invention relates to a method of obtaining hydrogen by heat-decomposing a hydrocarbon gas (herein after, referred to as methane) into hydrogen and carbon.

When methane is heated to 500 to 1000° C. in a state where no oxygen is present, it decomposes into nC and ₂nH₂ (CnH₂n⁺₂→nC+₂nH₂). However, this reaction is an endothermic reaction, and there is a necessity that the system is continuously heated during the operation in order to heat methane and make up for the heat loss of the reaction furnace. The larger the difference between the heat quantity for this heating and the heat quantity of hydrogen produced on the hydrogen side, the more useful a reforming apparatus of methane is obtained.

For this reason, important technical objects are what method the heat-decomposition of methane is performed with, how the heat loss of the heating furnace can be made small, and whether the lost heat quantity can be recovered and used or not.

In a conventional method, the inside of a tube-shaped furnace in which a catalyst is filled is heated to 700 to 1000° C. from the outside, methane is made to contact with the heated catalyst by introducing methane into the tube to decompose it, and hydrogen and carbon are extracted from an outlet (Journal of The Japan Petroleum Institute, vol. 40, No. 1, 2, and 3, 1997).

However, because methane is externally heated in this method, fuel efficiency is poor and a large amount of LPG and electric power is used, and it cannot be put to practical use.

There is a necessity of heating continuously during operation in order to produce hydrogen continuously without generating CO₂ from a hydrocarbon gas.

### SUMMARY OF THE INVENTION

In view of the above-described situation, the present invention is made to be a method of reforming hydrocarbon with an oxyhydrogen flame using a three-tube burner wherein an operation of removing air from an entire apparatus, an operation of making crude hydrogen by heat-decomposing methane, and an operation of producing hydrogen with the crude hydrogen as a fuel are performed, which includes arranging a mesh metal catalyst tube at a tip of an inner tube of a blowpipe and an outer tube of the blowpipe of the burner; covering the metal catalyst tube with a ceramic insulating tube; heating the metal catalyst tube with an oxyhydrogen flame from between the inner tube of the blowpipe and the outer tube of the blowpipe of the burner; and decomposing hydrocarbon from the inner tube of the blowpipe into hydrogen and carbon, in order to perform heating only when necessary during operation for producing hydrogen continuously without generating CO₂ from a hydrocarbon gas.

Further, a thin plate of palladium, nickel, chromium, cobalt, or platinum is used in the metal catalyst tube in order for the present invention to be applied to many types of hydrocarbon and ranges of decomposition temperature.

Furthermore, in the present invention, in order to easily perform the operation and control to produce hydrogen only from hydrocarbon and oxygen, all of the operation of removing air from the entire apparatus, the operation of making crude hydrogen by heat-decomposing hydrocarbon, and the operation of producing the crude hydrogen as a fuel can be made to be performed with operation of a valve.

### BRIEF DESCRIPTION OF THE DRAWINGS

FIG. 1 is a vertical cross-sectional view of a reaction furnace of the present invention in which methane is decomposed into hydrogen and carbon;

FIG. 2 is a cross-sectional view of the inside of the reaction furnace of the present invention; and

FIG. 3 is an overall view of an apparatus for producing hydrogen of the present invention.

### DESCRIPTION OF THE PREFERRED EMBODIMENT

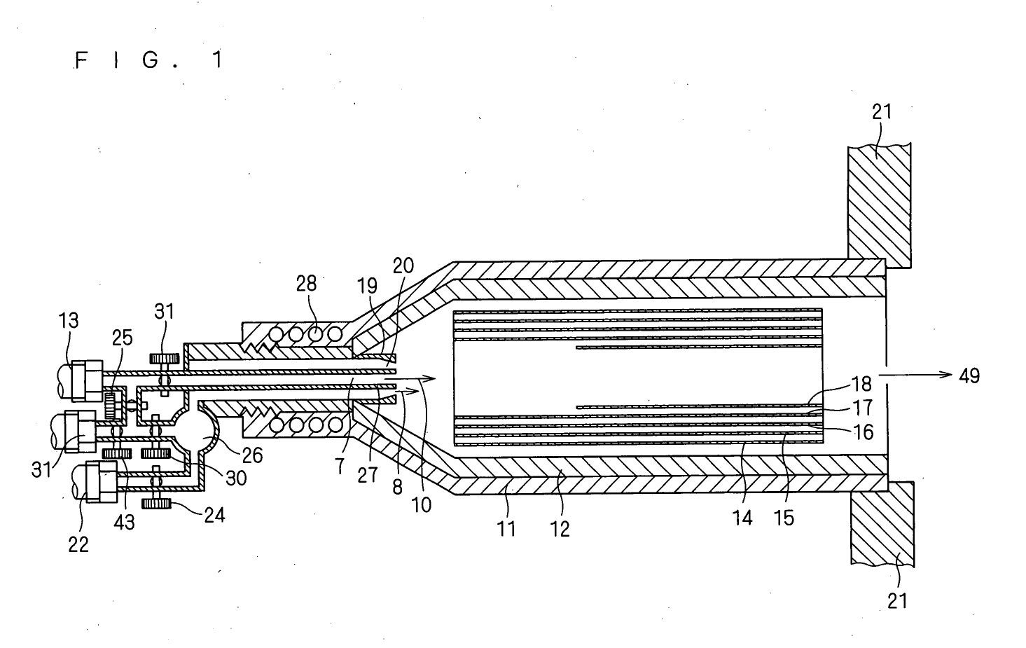

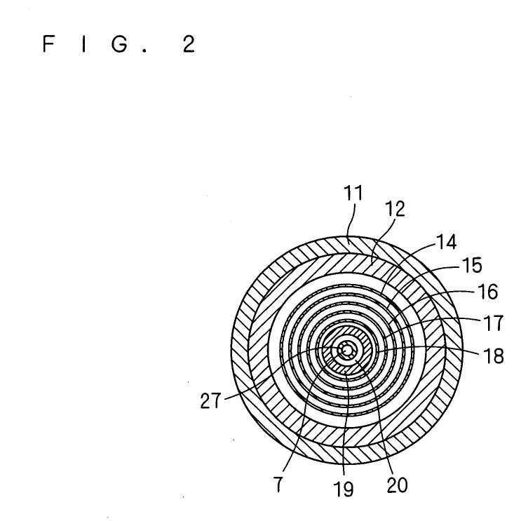

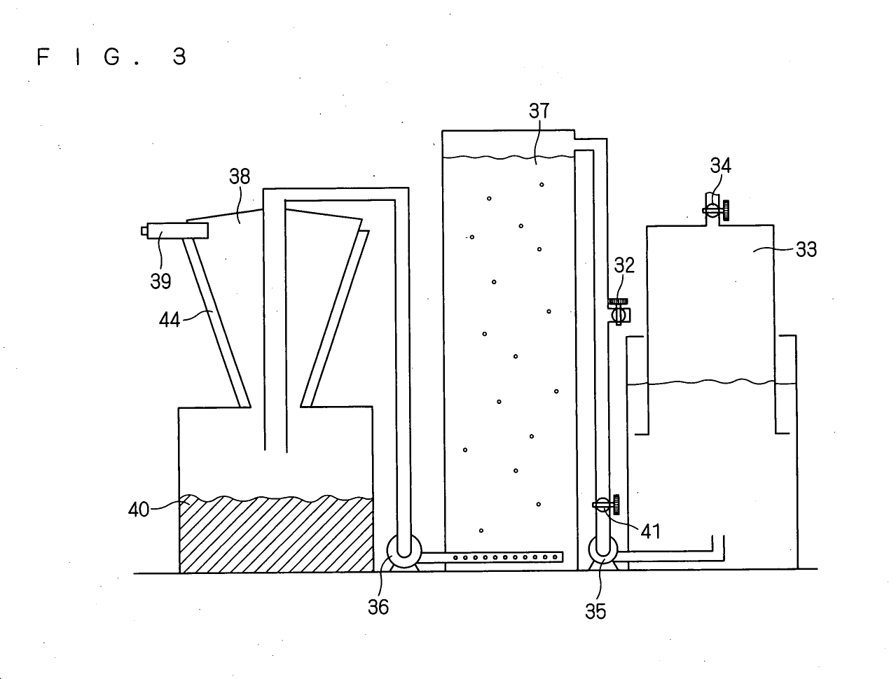

FIG. 1 is a vertical cross-sectional view of a reaction furnace of the present invention in which methane is decomposed into hydrogen and carbon, FIG. 2 is a cross-sectional view of the inside of the reaction furnace of the present invention, and FIG. 3 is an overall view of an apparatus for producing hydrogen of the present invention.

An internal heating system is adopted in the present invention as the heating method of methane.

It is a method of blowing out an oxyhydrogen flame from an outer tube of a burner covered with a thick insulating material, directly heating methane by blowing in methane from an inner tube, and at the same time decomposing methane into hydrogen and carbon by a catalyst provided in the flame of the burner, and there are advantages that not only that the heat efficiency is good but also that the by-production of CO₂ is small, the apparatus is small and the heat loss is small.

The present invention is to economically produce hydrogen only with methane and oxygen without by-producing CO₂. The operation is divided into the following three steps.

1^{st} Step: an operation of removing air from the entire apparatus

2^{nd} Step: an operation of making crude hydrogen by heat-decomposing methane

3^{rd} Step: an operation of producing hydrogen with the crude hydrogen produced in the previous step as a fuel

The 1^{st} step of operating the apparatus of the present invention is to remove air from the entire apparatus shown in FIG. 3. Air inside the apparatus can also be removed using an inert gas such as argon or nitrogen. However, in the present invention, an object thereof is achieved using only methane and oxygen.

First, methane is supplied through a gas input port in FIG. 1 and oxygen is supplied through a different gas input port 22 from each cylinder, an equivalent mixed gas of methane and oxygen is made in a gas mixing chamber 26 by gradually opening valves 25, 30, and 24, the mixed gas is sent into a blowpipe outer tube 19 of the burner, and is blown out of a space 20 between the blowpipe outer tube 19 and a blowpipe inner tube 20 as shown by an arrow 8. Moreover, a valve 43 of the gas input port 13 is kept closed.

The ignited mixed gas generates high heat and a large amount of CO₂ as shown by an arrow 49, exhausts remaining air from an exhaust port 32 from the entire apparatus shown in FIG. 3, and can make the entire apparatus clear with O₂ in the air.

In the operation of the 2^{nd} step, methane is blown into the center of the oxygen methane flame from a blowpipe inner tube 7 of the burner by closing the exhaust port 32 and opening a valve 31 while keeping the high heat by the above-described operation, and the methane is immediately heated and sent into metal catalyst tubes 14, 15, 16, 17, and 18, and decomposed into carbon and hydrogen. The metal catalyst tubes 14, 15, 16, 17, and 18 are mesh cylinders, the metal catalyst tube 18 is a palladium thin plate, the metal catalyst tube 17 is a nickel thin plate, the metal catalyst tube 16 is a chromium thin plate, the metal catalyst 15 is a cobalt thin plate, the metal catalyst 14 is a platinum thin plate, and they are arranged in a concentric circle at regular intervals so that carbon does not pile up by blowing through in the direction of the arrow 49.

As for the decomposed gas blown out as shown by the arrow 49, as shown in FIG. 3, carbon is separated in a cyclone tower 38, and the decomposed gas is washed in an alkaline chemical solution in a water-washing tower 37 by pressurizing with a pump 36, CO₂ is removed, and the gas is stored in a floating type hydrogen tank 33 through a valve 41 by pressurizing with a pump 35.

In the operation of the 3rd step, the hydrogen produced with the above-described operation and stored in the floating type hydrogen tank 33 is sent to the gas input port 31 in FIG. 1 with an operation of a valve 34 in the upper part of the tank, a mixed gas of hydrogen and oxygen is made in the gas mixing chamber 26 by opening valves 43, 30, and 24, and closing the valve 25, and the gas is ignited by being spouted from the blowpipe outer tube 19 as shown by the arrow 8.

With this operation, the valve 31 is opened when the metal catalyst tubes 14, 15, 16, 17, and 18 are heated to a high temperature, methane is blown into the metal catalyst tubes 14, 15, 16, 17, and 18 that are heated by an oxyhydrogen flame as shown by an arrow 10 from a burner inner tube 27 and immediately heated up to 500 to 1000° C. The methane is decomposed into hydrogen and carbon and sent into the cyclone tower 38 from an input port 39 of hydrogen and carbon as shown by the arrow 49, carbon is separated here, and the gas is cooled with a cooling jacket 44 of the outer wall of the cyclone tower 38, sucked with the pump 36, compressed, passed through the water-washing tower 37, compressed with the pump 35, passed through the valve 41, and stored in the floating type hydrogen tank 33.

Moreover, a ceramic insulating tube 12 is attached in the inside of a metal external structural part 11 of a burner heating part so that a high temperature of the heating furnace can be kept. A water-cooling type jacket 28 is equipped to prevent overheating of the burner. This metal external structural part 11 is fixed in contact with an end plate 21. One or a few of the burner heating part (s) is/are mounted in the cyclone tower 38 as shown in FIG. 3. The cooling jacket 44 is mounted in the cyclone tower 38, and the heat thereof can be used in cooling and heating. Moreover, a reference numeral 40 in the figure is carbon.

In the present invention, heating is performed only when necessary during operation to continuously produce hydrogen from a hydrocarbon gas without generating CO₂. However, it can be used also in cleaning of an exhaust gas of a normal internal combustion engine.

Because the present invention is a method of reforming hydrocarbon with an oxyhydrogen flame using a three-tube burner wherein an operation of removing air from an entire apparatus, an operation of making crude hydrogen by heat-decomposing methane, and an operation of producing hydrogen with the crude hydrogen as a fuel are performed, which includes arranging a mesh metal catalyst tube at a tip of an inner tube of a blowpipe and an outer tube of the blowpipe of the burner; covering the metal catalyst tube with a ceramic insulating tube; heating the metal catalyst tube with an oxyhydrogen flame from between the inner tube of the blowpipe and the outer tube of the blowpipe of the burner; and decomposing hydrocarbon from the inner tube of the blowpipe into hydrogen and carbon, it is made to perform heating only when necessary during operation for producing hydrogen continuously without generating CO₂ from a hydrocarbon gas.

Further, because a thin plate of palladium, nickel, chromium, cobalt, or platinum is used in the metal catalyst tube, the present invention can be applied to many types of hydrocarbon and a wide range of decomposition temperatures.

Furthermore, because the operation of removing air from the entire apparatus, the operation of making crude hydrogen by heat-decomposing hydrocarbon, and the operation of producing hydrogen with the crude hydrogen as a fuel are made to be able to be performed with operation of a valve in the present invention, the operation and control to produce hydrogen only from hydrocarbon and oxygen can be easily performed.

What is claimed is:

1. A method of reforming hydrocarbon with an oxyhydrogen flame using a three-tube burner wherein an operation of removing air from an entire apparatus, an operation of making crude hydrogen by heat-decomposing methane, and an operation of producing hydrogen with the crude hydrogen as a fuel are performed, which comprises
arranging a mesh metal catalyst tube at a tip of an inner tube of a blowpipe and an outer tube of the blowpipe of the burner;
covering the metal catalyst tube with a ceramic insulating tube;
heating the metal catalyst tube with an oxyhydrogen flame from between the inner tube of the blowpipe and the outer tube of the blowpipe of the burner; and
decomposing hydrocarbon from the inner tube of the blowpipe into hydrogen and carbon.

2. The method of reforming hydrocarbon according to claim 1 wherein a thin plate of palladium, nickel, chromium, cobalt, or platinum is used in the metal catalyst tube in order to be applied to many types of hydrocarbon and ranges of decomposition temperature.

3. The method of reforming hydrocarbon according to claim 1 that produces hydrogen, wherein all of the operation of removing air from the entire apparatus, the operation of making crude hydrogen by heat-decomposing hydrocarbon, and the operation of producing the crude hydrogen as a fuel are made to be performed with operation of a valve in order to make the operation and control to produce hydrogen only from hydrocarbon and oxygen easy.
